(19) United States
(12) Patent Application Publication
(10) Pub. No.: US 2024/0042910 A1
(43) Pub. Date: Feb. 8, 2024

(54) MOTOR VEHICLE

(71) Applicant: ZF Friedrichshafen AG, Friedrichshafen (DE)

(72) Inventors: Lenard PETRZIK, Diepholz (DE); Ludger RAKE, Steinfeld (DE)

(73) Assignee: ZF Friedrichshafen AG, Friedrichshafen (DE)

(21) Appl. No.: 17/641,782

(22) PCT Filed: Sep. 9, 2020
(86) PCT No.: PCT/EP20/75149

§ 371 Date: Mar. 9, 2022

(30) Foreign Application Priority Data
Sep. 11, 2019 (DE) 10 2019 213 846.2

(51) Int. Cl. B60N 2/75

(52) U.S. Cl. CPC B60N 2/797

(57) ABSTRACT

A motor vehicle comprising at least one seating device, in particular a driver's seat, a control device for controlling at least one function of the motor vehicle and an operating device having at least one operator control device for operating the control device on the part of the user, wherein the at least one operator control device is supported on a bearing or mounting device which is designed to change the position of the operator control device as a function of a seat position.

The invention relates to a motor vehicle, comprising at least one seat assembly, in particular a driver's seat, a control unit for controlling at least one function of the motor vehicle, and a control device having at least one controller for control of the control unit by the user.

Motor vehicles with seat assemblies are known in principle from the prior art. Such seat assemblies usually have a control unit for controlling a function or a plurality of functions of the motor vehicle, for example functions relating to a driving mode or comfort functions, for example multimedia or infotainment applications. It is further known in the prior art that comfort during operation of the controller by means of which a user of the motor vehicle can control the at least one function of the motor vehicle is dependent on the position of the user, in particular the current position and orientation of the seat assembly on which the user is seated. In other words, a more or less comfortable operating position can be reached according to the currently chosen seat position, for example in dependence on the height of the user.

For example, in a particular seat position, the user can position an arm for operating the controller in such a manner that no further arm movement is necessary for operating the controller, for example a hand of the user rests on the controller. However, this applies only to a selected seat position, so that, depending on the height of the user or the currently adjusted seat position, the user has to move his hand or his arm in order to be able to operate the controller. For example, in motor vehicles in which the seat assembly can be moved into a rest position or a travel position, operation of a control device that is fixedly installed in the motor vehicle is possible only with difficulty or in some circumstances not at all.

In particular in view of autonomous driving operation, in which seat assemblies are not necessarily oriented in the direction of travel throughout the entire operation but can also face against the direction of travel in other seat positions and can be moved between a plurality of seat positions, comfortable operation of such a controller that is fixedly installed, in particular fixedly installed in the center console, is not possible.

The object underlying the invention is to provide a motor vehicle that is improved in comparison, in which in particular more comfortable operation of a controller in different seat positions is possible.

The object is achieved by a motor vehicle having the features of claim 1. Advantageous embodiments are the subject of the dependent claims.

As described hereinbefore, the invention relates to a motor vehicle having at least one seat assembly, for example a driver's seat, which has a control unit which is configured to control one or more functions of the motor vehicle. To this end, the motor vehicle has a control device which provides a controller, so that a user is able to operate the control unit.

The invention is based on the finding that the at least one controller is mounted on a mounting device which is configured to change the position of the controller in dependence on a seat position. In other words, the controller is not arranged in a fixed position in the motor vehicle, for example on a center console, but the controller is mounted by means of a mounting device which is able to change the position of the controller in dependence on a chosen seat position. It is thus possible, in dependence on the currently adjusted position of the seat assembly, or when the position of the seat assembly is changed, also to change the position of the controller, for example in that the mounting device can be correspondingly moved. As is described hereinbelow, the mounting device can be moved itself or together with the seat assembly.

It is thus possible that the user of the motor vehicle is able comfortably to operate the controller and thus comfortably to operate the control unit at all times and independently of the currently adjusted seat position, or the currently adjusted position of the seat assembly in the motor vehicle. Within the context of this application, the term “seat position” is clearly to be understood as meaning on the one hand the position of the seat assembly within the vehicle and on the other hand the orientation of the seat, in particular about the vertical axis and/or about the transverse axis and/or the longitudinal axis of the motor vehicle. In particular, it is also possible to consider the positioning, or movement or location, of individual segments of the seat assembly and thus to position the controller. Modern seat assemblies have a plurality of seat adjustments by means of which individual segments can be moved relative to other segments of the seat assembly. For example, a backrest inclination or a seat inclination and the like can influence the seat position, for example in order to determine a distance from the controller. Thus, for any seat adjustment, the user can compensate for or purposively adjust a corresponding adjustment of the position of the controller by means of the mounting device, so that comfortable operation is possible.

As described hereinbefore, the controller can be provided for operating the control unit, wherein any function of the motor vehicle can be controlled via the controller. Of course, it is likewise possible that only certain functions of the motor vehicle are controlled via the controller. It is thereby possible inter alia that comfort functions, safety functions, changes to a current state of the motor vehicle, for example a gear selection, a chosen driving state or individual devices of the motor vehicle can purposively be controlled, such as, for example, an air-conditioning system, a heater, windows or influencing of the seat assembly, as well as multimedia or infotainment applications and the like.

The user is thus able to choose or specify a corresponding position of the controller for the particular position of the seat, so that an operating position in which the driver can comfortably operate the control unit by means of the controller is always possible. If, for example, the motor vehicle is in a state in which the seat position of the seat assembly is facing against the direction of travel and the seat inclination or backrest inclination has a defined inclination angle, the controller can be correspondingly positioned so that the user can operate the controller comfortably, in particular without moving his arm.

Inter alia, it is thereby possible to configure the mounting device such that it is coupled in terms of movement with the seat assembly. As a result, an operating position adjusted, or selected or determined, by the user is maintained even when the seat assembly is moved. In other words, it is possible to maintain the selected operating position when the seat assembly is displaced about or along one of the movement axes of the seat assembly, for example in the case of a change of the seat inclination, the backrest inclination or the relative position of the seat assembly within the motor vehicle. In other words, a distance between a placed-down position or resting position of the hand of the user and the controller can be kept constant over the movement or during the movement of the seat assembly. The user can thus always operate the controller comfortably independently of the currently chosen seat position or when the seat position is changed.

The coupling of the movement of the mounting device with the seat assembly can thereby be limited to one of the movement axes, or to a movement along a movement axis or about one of the movement axes, that is to say the mounting device, for example in the case of a movement of the seat assembly along a movement axis, is coupled in terms of movement with the seat assembly, while in the case of a movement along a different movement axis or about a different movement axis, the mounting device can be decoupled from the seat assembly. It is thus possible, for example, that, in the case of a movement of the seat assembly along the longitudinal axis of the motor vehicle, the mounting device and the seat assembly are coupled in terms of movement, but the mounting device is decoupled from the seat assembly in the case of a movement of the seat assembly along the vertical axis of the motor vehicle. Of course, all combinations of a coupling of the movement of the mounting device with the seat assembly about one or more or along one or more movement axes are possible.

For example, the mounting device can be movable synchronously with the seat assembly, so that, in the case of a movement of the seat assembly, or in the case of a change of the seat position, a synchronous movement of the mounting device can be carried out, which leads to the operating position being maintained, for example the distance from the mounting device and thus the distance between the controller and the seat assembly remains constant. Thus, in the case of a change of the position of the seat assembly, or a change of the orientation of the seat assembly, a synchronous change of the position and/or of the location of the mounting device and thus of the controller can be carried out. In other words, if a change of the seat position is effected by the user or as a result of a change of the driving state, a corresponding synchronous change of the position of the controller can be carried out. In addition to a simultaneous change in the position of the controller, it is of course possible to change the seat position and the position of the controller one after the other.

In one embodiment of the motor vehicle, it can be provided that the mounting device is arranged on the seat assembly, in particular in an armrest or on a seat surface of the seat assembly. It is thus possible that the controller itself is arranged directly on the seat assembly, for example in or on an armrest or in or on a seat surface of the seat assembly. It is thus ensured that a change in the position or orientation of the seat assembly is accompanied by a synchronous change in the position of the controller. The controller, as described hereinbefore, can thereby be arranged by means of the mounting device on the armrest or in the armrest or both armrests of the seat assembly. In dependence on the present movement of the seat assembly, or in dependence on the change in the seat position, that is to say depending on whether a movement takes place along a movement axis and/or about a movement axis, a decoupling of the mounting device and the seat assembly for at least one movement axis can also be present here.

For example, the mounting device arranged on the seat assembly can be moved together with the seat assembly along the movement axis, wherein, for example, a mounting device arranged on the armrest can be inclined differently to the seat assembly independently of the seat assembly by changing the inclination of the armrest relative to the seat assembly. It is likewise possible to provide the mounting device itself on the seat assembly so as to be movable, so that the position of the controller on or in the seat assembly can likewise be changed. The mounting device arranged on or in the seat assembly can thus be moved relative to the seat assembly, that is to say along the seat assembly, in order to permit as comfortable an operating position as possible for the user of the motor vehicle.

To this end, the mounting device can, for example, be movably arranged in the armrest or on the armrest of the seat assembly, so that, in dependence on the selected seat position, a corresponding position of the controller can be adopted. Within the context of this application, an automatic movement of the controller into the required operating position can be provided, wherein it is likewise possible that the user himself carries out positioning, that is to say a movement, of the mounting device, in order to move the controller into the desired position. Therefore, automatic, semi-automatic or manual movement of the mounting device is possible. Of course, a plurality of controllers with corresponding mounting devices which can be moved synchronously or independently of one another can be provided on or in the seat assembly. For example, it is possible to provide controllers, which can be provided in particular for different control tasks, in both armrests.

According to a further embodiment of the motor vehicle according to the invention, it can be provided that the mounting device is formed spatially separately from the seat assembly and is coupled with a movement device which is configured to change the position of the mounting device. Thus, alternatively or in addition to the above-described arrangement of the mounting device on or in the seat assembly, the mounting device can be arranged spatially separately from the seat assembly. To this end, the mounting device can be coupled with the movement device, which is configured to change the position of the mounting device and thus also to change the position of the controller as a whole. Of course, the movement device can likewise be operated automatically, semi-automatically or manually, so that, even in the case of the mounting device formed spatially separately from the seat assembly, the user can correspondingly carry out the positioning of the controller. Relative positions between the seat assembly and the controller are thereby likewise adjustable as desired.

The movement device can further be configured to move the mounting device into a desired position, in particular in relation to the position of the seat assembly, in particular a position of a backrest of the seat assembly. Accordingly, the movement device configured separately from the seat assembly can purposively be used to move the mounting device, and thus the controller coupled with the mounting device or arranged on the mounting device, into a desired position. The desired position can be specified, for example, for one or more positions of the seat assembly. The desired position can thereby be defined in particular relative to the seat assembly, for example an armrest of the seat assembly. It is thus possible that an operating position that is comfortable for the user is assumed, since a defined distance between an armrest and the controller can be specified as the desired position of the mounting device, so that a distance chosen for a comfortable operating position is adjusted.

The backrest or armrest, for example, can thereby be coupled in terms of movement with the seat assembly, in particular arranged on the seat assembly. The armrest and/or the seat assembly are thereby relatively movable in the interior of the motor vehicle, so that, when the armrest and/or the seat assembly is moved, a movement of the mounting device is possible, in order to carry out the position of the mounting device of the movement of the seat assembly. The movement device can be arranged, for example, in the region of the center of the vehicle, in particular in the region of a center console of the motor vehicle, and correspondingly moved into the various desired positions in order to reach the operating position. Specifically, a defined position in relation to an armrest can consequently be adjusted, so that the controller can comfortably be operated with an arm placed on the armrest.

According to a further embodiment, it can be provided that the at least one controller has at least one control element which is in the form of a touch-sensitive element, in particular a touch input field, and/or in the form of a push element, in particular a button, and/or in the form of a selector element, in particular a selector wheel, and/or in the form of a rocker element and/or in the form of a slide element and/or in the form of an MRF control element.

Within the scope of this application, an MRF control element is understood as being a magnetorheological fluid element which comprises an excitable carrier fluid, so that the viscosity of the carrier fluid can be adjusted by corresponding activation of the element. The operating resistance on operation or actuation of the control element can thus be adjusted. The user consequently feels a higher or lower resistance on operating the control element depending on the currently adjusted viscosity. In other words, the control element can be made easier to move or more difficult to move, and the user can thus be provided with feedback about the control task currently being carried out. It is thereby possible inter alia to provide haptic feedback about which menu or which function the user of the motor vehicle is controlling at that time.

The controller can be configured inter alia to control a driving state of the motor vehicle, in particular a driving mode and/or a current gear, and/or an infotainment function and/or an entertainment function and/or a driver assistance system and/or a comfort function, in particular an air-conditioning system and/or a seat function. In other words, the user of the motor vehicle can use the controller to control the at least one control unit, so that the control unit can correspondingly control these or further functions. It is thereby possible, by different combinations of control elements, that a plurality of functions can be controlled by the user by means of a single controller, so that the user, in the preferred operating position, does not have to make any further arm movements or hand movements but can rest his hand, for example, on the control element by means of which the plurality of functions of the motor vehicle can be controlled.

According to a further embodiment, the control device can have an initiation device which is configured to move the at least one controller or at least one control element of the controller between an active position and an inactive position, in particular to uncover and/or deploy from a surface of the mounting device at least part of the controller. In other words, it is thus possible to move the controller or at least a control element of a controller between an active position and an inactive position. In the active position, the user of the motor vehicle is able to operate the controller, in particular the control element, and in the inactive position the control element of the controller can be correspondingly inactivated. For example, on changing from the active position into an inactive position, the controller can be moved away from the operating position, so that this region is available for movements of the user, the controller is thus not in the way.

Inter alia, the controller can thereby be folded out, folded away, deployed, retracted and the like, so that, if the user needs the controller, it can be moved into the active position in order to allow the control unit to be controlled. Correspondingly, if the user no longer needs the controller, it can be moved out of the active position into the inactive position, so that incorrect operations or accidental operations can be excluded. In particular, it can be provided that the controller, on changing to the active position, is uncovered or deployed from a surface of the mounting device. Of course, on moving from the surface or on uncovering, different movement patterns can be carried out, so that the controller is, for example, folded out or folded in, deployed or retracted linearly or moved following a specific movement curve.

The invention relates additionally to a control device for a motor vehicle according to the invention, as described hereinbefore. Of course, all the advantages, details and features which have been described in relation to the motor vehicle according to the invention are applicable in their entirety to the control device according to the invention.

The invention will be explained hereinbelow by means of exemplary embodiments with reference to the figures. The figures are schematic illustrations and show:

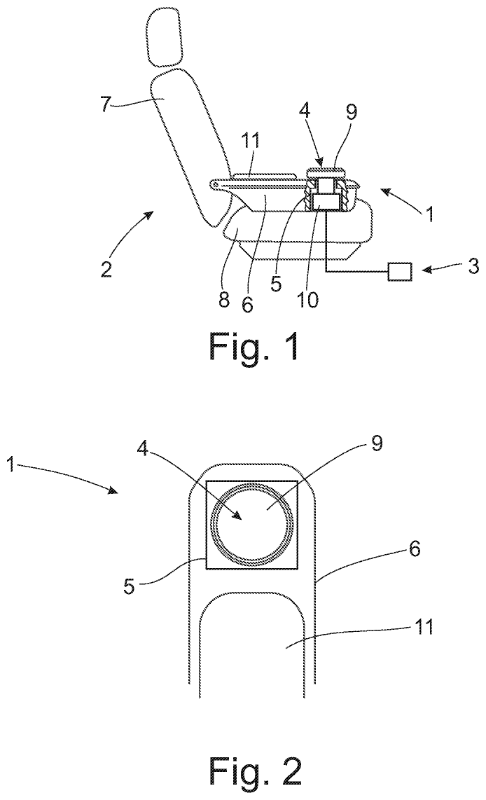

FIG. 1 a seat assembly of a motor vehicle according to the invention in a side view;

FIG. 2 a control device according to the invention in a plan view according to a first exemplary embodiment;

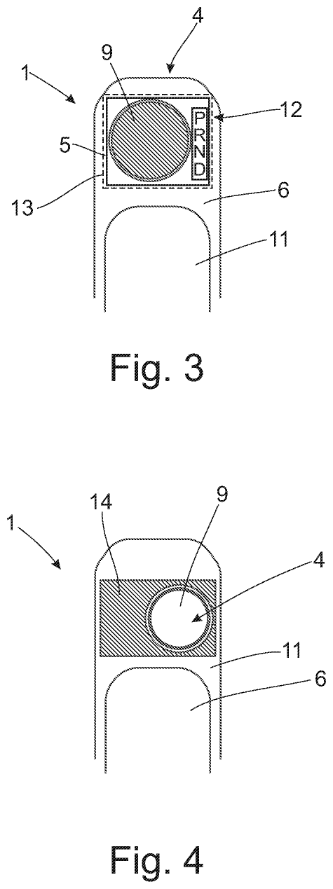

FIG. 3 a control device according to the invention in a plan view according to a second exemplary embodiment;

FIG. 4 a control device according to the invention in a plan view according to a third exemplary embodiment; and

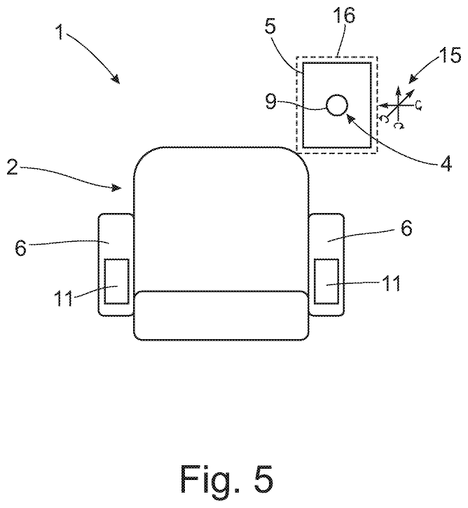

FIG. 5 a control device according to the invention in a plan view according to a fourth exemplary embodiment.

FIG. 1 shows a detail of a motor vehicle (not shown), comprising a control device 1, a seat assembly 2, for example a driver's seat, and a control unit 3 which is connected to the control device 1. In this exemplary embodiment, the control device 1 is configured to control at least one function of the motor vehicle, wherein control of the control unit 3 by the user is possible by means of the control device 1. To this end, the control device 1 has a controller 4 by means of which the user of the motor vehicle can interact in order thus to control the control unit 3 and accordingly control the at least one function of the motor vehicle.

The controller 4 can be configured in particular to control a driving state of the motor vehicle, in particular a driving mode and/or a current gear, and/or an infotainment function and/or an entertainment function and/or a driver assistance system and/or a comfort function, in particular an air-conditioning system or a seat function. Ultimately, it is thus possible to control one or more arbitrary functions of the motor vehicle or different devices of the motor vehicle in that the user operates the corresponding controller 4, with which one or more functions can be associated. To this end, the controller 4 can have a plurality of control elements or can have multifunctional control elements, with each of which one or more functions is/are associated. Likewise, the control device 1 can have a plurality of controllers 4 for different control tasks.

In the exemplary embodiment shown, the controller 4 is mounted in a mounting device 5, namely in an armrest 6 of the seat assembly 2. The mounting device 5 is configured to change the position of the controller 4 in dependence on a seat position. In other words, the controller 4 is arranged in the armrest 6 of the seat assembly 2 and thus coupled in terms of movement with the seat assembly 2. If the user places his arm on the armrest 6 so that his hand coincides with the position of the controller 4, this operating position is maintained in the case of an adjustment of the seat position, for example of a position of a backrest 7 of the seat assembly 2, or an adjustment of the position of a seat surface 8 of the seat assembly 2.

In other words, it is possible, independently of the chosen seat position, in particular in relation to a longitudinal axis and/or a transverse axis and/or a vertical axis of the motor vehicle or of the seat assembly 2, to keep an operating position constant so that comfortable operation of the controller 4 is possible. The controller 4 can thereby be integrated directly into the armrest 6 and thereby coupled with the seat assembly 2, or the mounting device 5 can be in the form of an additional movable unit which is movable relative to the armrest 6. In the last-mentioned case it is additionally possible to adjust an operating position of the controller 4 relative to the armrest 6, and thus to the seat assembly 2, in which the controller 4 is moved by means of the mounting device 5. The position of the controller 4 chosen by means of the mounting device 5 is clearly maintained in relation to the seat assembly 2 when the seat assembly 2 is adjusted into a different seat position.

In this exemplary embodiment, the controller 4 has a control element 9 which is in the form of an MRF rotary pushbutton and accordingly has an MRF actuator 10 which is connected to the control unit 3. It is thereby possible, in dependence on the currently chosen control task, to adapt the viscosity of the carrier fluid in the MRF actuator 10 in order thus to provide the user with haptic feedback as to which control task is currently being performed.

FIG. 2 shows a plan view of the controller 4 of the control device 1 according to the embodiment shown in FIG. 1. The armrest 6 has an arm support 11 on which part of the arm of a user can be placed, for example the ulna or the elbow of the user, wherein a hand of the user can rest on the controller 4 in order to operate it. By means of the mounting device 5 it is further possible to move, for example displace in translation or incline, the controller 4 relative to the armrest 6. As described hereinbefore, it is likewise possible to integrate the mounting device 5 fixedly in the armrest 6, so that the controller 4 is configured so as to be coupled in terms of movement together with the armrest 6.

FIG. 3 shows a control device 1 according to a second exemplary embodiment, wherein the controller 4 and a further controller 12 are provided. The controller 4 again has a control element 9 which is in the form of an MRF rotary pushbutton. In this exemplary embodiment, the control element 9 additionally has a touch input field on the upper side of the control element 9, via which, for example, gesture control or further touch-sensitive inputs can take place. The controller 4 can thereby be associated, for example, with infotainment or comfort applications, for example in order to control a multimedia system of the motor vehicle. The controller 12 can be provided for further functions of the motor vehicle, for example for controlling a driving state, in particular a gear selection.

The two controllers 4, 12 can be mounted via the mounting device 5 in the armrest 6 of the seat assembly 2, wherein the mounting device 5 can again be movable relative to the armrest 6. As described hereinbefore, it is likewise possible that the mounting device 5 is fixedly connected to the armrest 6.

In order to initiate the controllers 4, 12, that is to say to move them between an active position and an inactive position, the control device 1 has an initiation device 13. In this exemplary embodiment, the initiation device 13 is configured to deploy the controllers 4, 12 from the surface of the armrest 6, or to retract them into the surface and cover them. It is thus possible, if the user of the motor vehicle wishes to use the controllers 4, 12 in order to control one or more functions of the motor vehicle, to initiate the controllers 4, 12, that is to say to uncover them from the inactive position, in which the controllers 4, 12 are arranged in the armrest 6 and covered by a corresponding cover element (not shown), and deploy them from the surface of the armrest 6.

It is thereby possible to retract the controllers 4, 12, if they are not needed, and thus remove them from the field of activity of the user. This increases the comfort of the user, since the controllers 4, 12 are not arranged on the surface of the seat assembly 2 when they are not needed. Furthermore, accidental operation or incorrect operation of the controllers 4, 12 is prevented, since they are not accessible in the inactive position.

Further forms of initiation are of course likewise possible, so that the controllers 4, 12 can also be folded away or otherwise removed from the field of activity of the user. It is likewise conceivable that the function of the controllers 4, 12 is deactivated when they are changed to the inactive position so that, although they remain spatially in the same position, they no longer have any function. Should the user of the motor vehicle wish to use the controllers 4, 12 again, they can of course be brought into the active position again.

FIG. 4 shows a further embodiment of the control device 1 according to the invention, or of the motor vehicle according to the invention. In this exemplary embodiment, a controller 4 which has a control element 9 and a further control element 14 is provided. The control element 9 is in the form of an MRF rotary pushbutton, as described hereinbefore, wherein the second control element 14 is in the form of a touch display. In this example, by means of an initiation device 13 (not shown), the control element 14 can be deactivated and the control element 9 can be retracted, for example, into the surface of the control element 14. It is thereby again possible that the various control elements 9, 14 are associated with different functions which the user can perform.

FIG. 5 shows a further embodiment of the control device 1 according to the invention, in which there is provided a mounting device 5 which is configured spatially separately from the seat assembly 2 and also spatially separately from the armrest 6. As is indicated by the arrows 15, the mounting device 5 is again movable relative to the seat assembly 2, in particular relative to the armrest 6, about all movement axes and along all movement axes. Of course, it can likewise be provided to configure the mounting device 5 to be movable about only a limited selection and along a limited selection of movement axes. To this end, the mounting device 5 is coupled in terms of movement with a movement device 16 which ultimately performs the movements, that is to say moves the mounting device 5.

Thus, positioning of the mounting device 5 can be carried out by means of the movement device 16 according to the currently chosen seat position, that is to say a position of the seat assembly 2 within the motor vehicle, and in dependence on an orientation of the seat assembly 2 in the motor vehicle. If, for example, the seat assembly 2 is rotated about the vertical axis or moved laterally within the motor vehicle, the controller 4 can assume the corresponding distance from the armrest 6 again in order to keep a user's preferred operating position constant. To this end, the mounting device 5 can be moved synchronously with the seat assembly 2 in order that the controller 4 ultimately follows a movement of the seat assembly 2. It is thus possible that, in all states of the seat assembly 2, the control device 1 can be operated comfortably and the user does not have to make any additional arm movements or hand movements, for example, in order to reach the control device 1.

Of course, all the advantages, details and features shown in the individual embodiments can be interchanged with one another, applied to one another and combined with one another as desired. The individual controllers, in particular the individual control elements, can be interchanged and combined with one another as desired and arranged on different mounting devices together or on their own.

### LIST OF REFERENCE NUMERALS

1 control device
2 seat assembly
3 control unit
4 controller
5 mounting device
6 armrest
7 backrest
8 seat surface
9 control element
10 MRF actuator
11 arm support
12 controller
13 initiation device
14 control element
15 arrow
16 movement device

1. A motor vehicle, comprising:
at least one seat assembly;
a control unit configured to control at least one function of the motor vehicle; and
a control device having at least one controller for control of the control unit by a user,
wherein the at least one controller is mounted on a mounting device which is configured to change a position of the controller dependent, at least in part, upon on a seat position.

2. The motor vehicle of claim 1, wherein the mounting device is coupled in terms of movement with the seat assembly.

3. The motor vehicle of claim 1, wherein the mounting device is movable synchronously with the seat assembly.

4. The motor vehicle of claim 1, wherein the mounting device is arranged at least one of on or in the seat assembly.

5. The motor vehicle of claim 1, wherein the mounting device is configured spatially separately from the seat assembly and is coupled with a movement device which is configured to change a position of the mounting device.

6. The motor vehicle of claim 5, wherein the movement device is configured to move the mounting device into a desired position in relation to the position of the seat assembly.

7. The motor vehicle of claim 1, wherein the at least one controller has at least one control element comprising at least one of a touch-sensitive element, a touch input field, a push element, a button, a rotary element, a selector wheel, a rocker element, a slide element, or MRF control element.

8. The motor vehicle of claim 1, wherein the controller is configured to control at least one of:
a driving state of the motor vehicle;
a driving mode of the motor vehicle;
a current gear of the motor vehicle;
an infotainment function;
an entertainment function;
a driver assistance system;
a comfort function;
an air-conditioning system; or
a seat function.

9. The motor vehicle of claim 1, wherein the control device has an initiation device which is configured to move the at least one controller or at least one control element of the at least one controller between an active position and an inactive position.

10. A control device for a motor vehicle, the control device comprising:
at least one controller for control of a control unit by a user, the control unit configured to control at least one function of the motor vehicle,
wherein the at least one controller is mounted on a mounting device which is configured to change a position of the controller dependent, at least in part, upon on a seat position.

11. The motor vehicle of claim 4, wherein the mounting device is arranged at least one of in an armrest or on a seat surface of the seat assembly.

12. The motor vehicle of claim 6, wherein the movement device is configured to move the mounting device into a desired position in relation to a position of a backrest of the seat assembly.

13. The motor vehicle of claim 9, wherein the initiation device is configured to at least one of uncover or deploy from a surface of at least one of the mounting device or of the seat assembly at least a part of the controller.
